(19) United States
(12) Patent Application Publication
(10) Pub. No.: US 2020/0327821 A1
(43) Pub. Date: Oct. 15, 2020

(54) Method and System For Establishing User Preference Patterns Through Machine Learning

(71) Applicants: Lyndon Robert Holzheimer, Maroochydore (AU); Stephen Alan Huff, Maroochydore (AU); Paul David Sickling, Maroochydore (AU)

(72) Inventors: Lyndon Robert Holzheimer, Maroochydore (AU); Stephen Alan Huff, Maroochydore (AU); Paul David Sickling, Maroochydore (AU)

(21) Appl. No.: 16/306,386

(22) PCT Filed: Jun. 1, 2017
(86) PCT No.: PCT/AU2017/050526

§ 371 Date: Nov. 30, 2018

(51) Int. Cl. G09B 19/00; G06N 5/04; G06N 20/00; G06Q 30/02; G06Q 50/20; G09B 5/06; G09B 5/02; G09B 5/04

(52) U.S. Cl. CPC G09B 19/00; G06N 5/04; G06N 20/00; G09B 5/04; G06Q 50/20; G09B 5/065; G09B 5/02; G06Q 30/0204

(57) ABSTRACT

There is provided an adaptive incentivise education platform that provides educational content to a user via their mobile device. Usage information relating to how, when and what the user users is collected and analysed by machine learning to establish user preference patterns, which are used to update the user profile, and to predict what content would be most likely to be engaged by the user to achieve predetermined outcomes. The content is then selected and sent to the user.

### FIELD OF THE INVENTION

The present disclosure relates to an adaptive incentivised education platform. It further relates to a method of tailoring a learning program and to a dynamic system for providing educational content. In particular, the present disclosure relates to a method, platform and system that promotes behavioural change using gamification and incentivisation to affect behavioural intent. The present disclosure relates to a method, platform and system which builds and dynamically updates a user profile to tailor educational content and strategies to engage the user.

### SUMMARY

In one exemplary embodiment, the present disclosure is directed to an adaptive incentivised education platform that includes a server on which a software program of the education platform is executed. The software program has an algorithm which receives data indicative of monitored interactions of a user with educational content items disseminated to the user by the educational platform. The educational platform is configured to adapt or select further educational items for the user based on one or more gamification strategies and in accordance with an analysis by the algorithm of the data indicative of the user's interactions.

The software application preferably selects a gamification strategy based on the data received by the algorithm which is indicative of the user's interactions with the educational content items.

The algorithm may be configured to receive and process data indicative of the order in which the user interacts with different educational content items.

The education platform preferably includes a software application executed on a personal computing device of the user. The software application may be operable to track the order in which the user interacts with the different content items.

The software program may be configured to incentivise the user to interact with the educational content by offering rewards to the user for interacting with the content. The type of reward may be selected based on the monitored interaction of the user with the educational content items.

In another exemplary embodiment, the present disclosure is directed to a method of tailoring a learning program to a user. The method includes presenting content on a personal computing device of the user in two or more different formats. The preferred format in which the user chooses to consume the content is then monitored. A personal profile of the user is updated to reflect the preferred format. Content is sent or disseminated to the user with a bias to the user's preferred content format. The different formats may include video, photo, and text. Further, augmented reality (AR) or virtual reality (VR) formats may be used.

The method may include presenting the content to the user in two or more different modes. The preferred mode in which the user chooses to consume the content is monitored. The personal profile of the use is updated to reflect the user's preferred mode. Content is sent or disseminated to the user with a bias to the user's preferred mode of content. The different modes may include visual, audio, and kinaesthetic.

The method may include applying two or more different gamification strategies to how content is presented to best engage the user with the content. Gamification strategy results are monitored to determine which gamification strategies best engages the user. The user's personal profile is updated to reflect the gamification strategy which best engages the user. Content is sent or disseminated to the user with a bias to the gamification strategy which best engages the user. This enables a continual, adaptive feedback process that optimises the content and its method of dissemination.

The method may include grouping the user into one or more groups based on the user's personal profile. The learning program is tailored so that content disseminated to the user's personal computing device is based on the group into which the user is categorised. The user may be grouped into a specific group based on a comparison between data of the user's personal profile and a statistical data set.

The method may include datamining biographical information from multiple sources to build a comprehensive personal profile of the user.

The user's personal profile is preferably built by receiving user information from the user; receiving geo-location data of the personal computing device; and receiving preference data from the user. At least some of the user information may be received using an application programming interface to retrieve data from an otherwise distinct internet platform. The geo-location data may be used for pattern recognition to tailor the learning program.

In another exemplary embodiment, the present disclosure is directed to a dynamic system for providing educational content to a personal computing device. The dynamic system includes a central server including, or connected to, a database with educational content in different formats. The system includes a personal computing device associated with a user. The central server is operable to disseminate or send educational content to the personal computing device. The system includes a software application executed on a processor of the personal computing device. The application is configured to monitor the preferred format in which the user chooses to consume the content. The application communicates data indicating the preferred format to the central server.

The server is preferably configured to disseminate content to the user with a bias to the user's preferred format based on the data received from the software application. The database preferably includes educational content in video format, photo format, and text format.

The server may be configured to disseminate content to a user in two or more different modes. The software application is preferably configured to monitor the preferred mode in which the user chooses to consume the content. The software application communicates data indicating the preferred mode to the central server. The server is preferably configured to disseminate content to the user with a bias to the user's preferred mode, based on the data received from the software application. The database preferably includes educational content in the visual mode, audio mode, and kinaesthetic mode.

The server may be configured to have the software application apply two or more different gamification strategies. The software application is preferably configured to monitor which gamification strategy results in the best engagement by the user. The software application preferably communicates data indicating the gamification strategy which best engages the user to the central server. The server is preferably configured to bias the software application to apply the user's preferred gamification strategy based on the data received from the software application.

The server may be configured to group the user into one or more groups based on the user's profile. The server then tailors the content disseminated or sent to the personal computing device based on the group into which the user is categorised.

The server may be configured to match data of the user's profile to a statistical data set to group the user into a specific group.

The server may be configured to aggregate data of the user's profile by receiving user information; receiving geo location data of the personal computing device; and receiving preference data from the user.

The server may include an application programming interface configured to retrieve data from an otherwise distinct internet platform using login details of the user for the otherwise distinct internet platform.

In another aspect, there is provided adaptive incentivised education platform that includes a server on which a software program of the education platform is executed, said software program being configured to
analyse usage information indicative of monitored interactions of a user with educational content items disseminated to the user by the educational platform, the analysis resulting in the determination of user preference patterns;
generate a user profile from the user preference patterns;
adapt or select further educational items for presentation to the user based on one or more gamification strategies and in accordance with the generated user profile.

In one embodiment, the user profile is configured as a neural matrix.

In one embodiment, the analysis includes the analysis of information relating to the discrete actions performed or not performed by the user, as well as metadata associated with the user's actions and/or content that the user has interacted with.

In one embodiment, the analysis is by machine learning.

In one embodiment, the machine learning includes the steps of:

sampling usage information;

generating a training dataset;

training the machine learning model;

generating user preference patterns;

applying the user preference patterns to test dataset; and

generating a prediction of content to be transmitted to the user.

In one embodiment, the education platform further comprises at least one usage information database, and wherein the server is configured to receive and store usage information on said usage information database.

In one embodiment, the education platform further comprises a user database, and wherein the server is configured to store the generated user profile in the user database.

In one embodiment, the server is configured to determine user preference patterns without requiring a selection of alternative content by the user.

In one embodiment, the software application is configured to select a gamification strategy based on the user profile.

In one embodiment, the server is configured to determine an incentivisation strategy for incentivising the user to interact with the educational content by offering rewards to the user for interacting with the content.

In one embodiment, the type of reward is selected based on the user profile.

In one embodiment, the education platform further comprises a content database including stored content for presentation to a user.

In one embodiment, the stored content is associated with one or more modes selected from visual, audio, and kinaesthetic.

In one embodiment, the selection of visual, audio and/or kinaesthetic content for presentation to the user is determined in accordance with the user profile.

In one embodiment, a plurality of user preference patterns and user profiles are used to determine demographic preference patterns.

In one embodiment, the determination of demographic preference patterns is by machine learning.

In another aspect, there is provided a method of tailoring a learning program to a user, includes:
transmitting content to a personal computing device of the user for presentation to the user;
receiving usage information indicative of the users interaction with the content;
analysing the usage information to determine user preference patterns;
updating a personal profile of the user to reflect the determined user preference patterns; and
transmitting content to the user in accordance with the user's personal profile.

In one embodiment, the user preference patterns of a plurality of users are used to determine a demographic preference pattern.

In one embodiment, the analysis of the usage information is carried out by machine learning.

In one embodiment, the user profile is configured as a neural matrix.

In one embodiment, the analysis of the usage information includes the analysis of usage information relating to the discrete actions performed or not performed by the user, as well as meta data associated with the user's actions and/or content that the user has interacted with.

In one embodiment, the analysis is by machine learning.

In one embodiment, the analysis by machine learning includes the steps of:

sampling usage information;

generating a training dataset;

training the machine learning model;

generating user preference patterns;

applying the user preference patterns to test dataset; and

generating a prediction of content to be transmitted to the user.

In one embodiment, the method comprises the step of receiving and storing usage information on a usage information database.

In one embodiment, the method includes the storing of the generated user profile in a user database.

In one embodiment, the method includes the storing of content in association with a mode selected from visual mode, audio mode and kinaesthetic mode.

In one embodiment, the selection of content associated with one of the visual, audio and/or kinaesthetic modes for presentation to the user is determined in accordance with the user profile.

In one embodiment, the determination of user preference patterns does not require the receipt of a selection of alternative content by the user.

In one embodiment, the content formats include one or more selected from video, photo, virtual reality content, augmented reality content and text.

In one embodiment, the method includes determining demographic preference patterns from plurality of user preference patterns and user profiles.

In one embodiment, the determination of demographic preference patterns is by machine learning.

In one embodiment, the method includes categorising the user into one or more demographic groups based on the matching of the user's personal profile to a demographic preference pattern, and tailoring content transmitted to the user's personal computing device is based on the demographic group into which the user is categorised, and in accordance with demographic preference patterns.

In one embodiment, the method includes applying a selection of two or more different gamification strategies to how content is presented to best engage the user with the content in accordance with the user profile
generating a user preference pattern that reflects the gamification strategy that results in the best engagement by the user in the achievement of predetermined goals;
updating the user's personal profile in accordance with the generated user preference pattern; and
disseminating content to a user's computing device in accordance with the updated user's personal profile.

In one embodiment, the method includes datamining biographical information from multiple sources to build a comprehensive personal profile of the user.

In one embodiment, the user's personal profile is created from:

use information received from the user;

geolocation data received from the user's personal computing device; and

user preference patterns determined from usage information.

In another aspect, there is provided a dynamic system for providing educational content to a personal computing device, comprising:
a central server including, or connected to, a content database with educational content in different formats;
wherein said central server is configured to disseminate educational content to a personal computing device associated with a user, for presentation to a user;
said central server being configured to receive usage information from the personal computing device, the usage information being indicative of the interaction by the user with content presented to the user;
said central server being configured to determine user preference patterns from the usage information, and to update a personal profile of the user in accordance with the detected user preference patterns;
said central server being configured to select content for transmission to a user's personal computing device based on the user's personal profile.

In one embodiment, the educational content is disseminated to the user in a format corresponding with a preferred learning mode as determined from the user preference patterns.

In one embodiment, the content database includes educational content in video format, photo format, and text format.

In one embodiment, the received usage information includes information relating to the discrete actions performed or not performed by the user, as well as metadata associated with the user's actions and/or content that the user has interacted with.

In one embodiment, the content database includes educational content associated with at least one or more of a visual mode, audio mode, and kinaesthetic mode.

In one embodiment, the content database includes educational content associated with at least one or more different gamification strategies, and the server is configured to transmit content to a user's personal computing device associated with at least one of the gamification strategies in accordance with the user's user profile.

In one embodiment, the server is configured to determine demographic preference patterns from a plurality of user preference patterns and a plurality of user profiles,

In one embodiment, the demographic preference patterns are used to categorise a user into a demographic group.

In one embodiment, the server is configured to tailor the content selected for transmission to said user's personal computing device based on the demographic group into which the user is categorised.

It will be appreciated that reference herein to “preferred” or “preferably” is intended as exemplary only.

The reference to any prior art in this specification is not, and should not be taken as an acknowledgement or any form of suggestion that the prior art forms part of the common general knowledge in any country.

The claims as filed and attached with this specification are hereby incorporated by reference into the text of the present description.

### BRIEF DESCRIPTION OF THE DRAWINGS

FIG. 1 is a diagram of the functional elements of an adaptive incentivised education platform for tailoring a learning program and providing educational content in accordance with a preferred embodiment of the present disclosure.

FIG. 2 is a process diagram of a method of tailoring a learning program to provide educational content in accordance with a preferred embodiment of the present disclosure, implemented as part of the system of FIG. 1.

FIG. 3 is a diagram of a method of tailoring education in accordance with a preferred embodiment of the present disclosure, implemented as part of the system of FIG. 1.

FIG. 4 is a flowchart showing steps carried out in a method of tailoring a learning program to a user in accordance with a preferred embodiment of the present disclosure, implemented as part of the system of FIG. 1.

FIG. 5 is a schematic diagram illustrating an embodiment of a machine learning process for determining user preference patterns in accordance with an embodiment of the present disclosure; implemented as part of the system of FIG. 1.

### DETAILED DESCRIPTION OF THE DRAWINGS

Alternative embodiments of the disclosure will be apparent to those of ordinary skill in the art from consideration of the specification. It is intended that the specification and examples be considered as exemplary only, with a true scope and spirit of the disclosure being indicated by the claims which follow. It will be understood that the term “comprising” is intended to have a broad, open meaning and not limited to a particular embodiment.

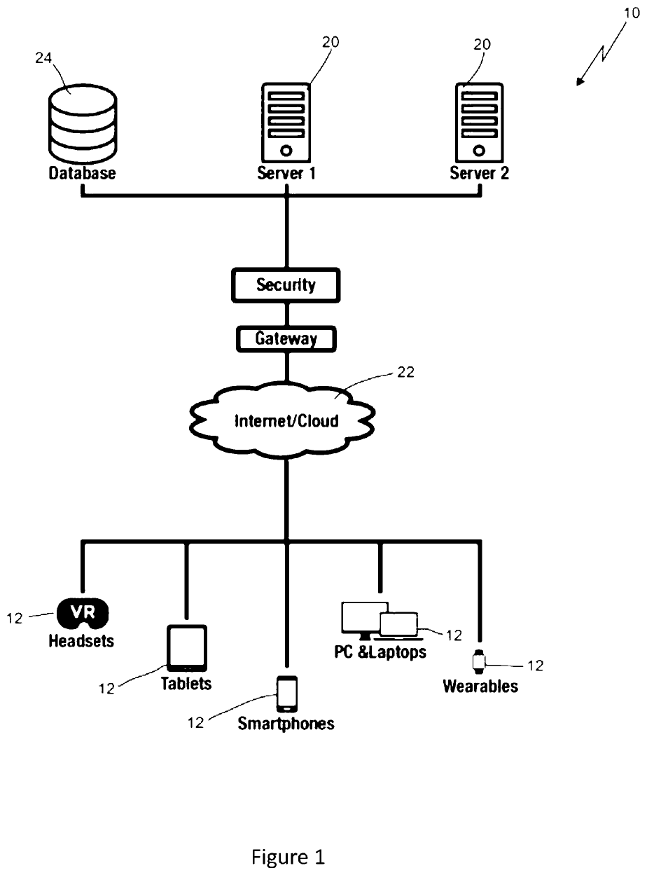

Referring to FIG. 1, a system or platform which provides adaptive learning programs to users of the system is generally indicated by reference numeral 10. System 10 uses mobile application technology in communication with system specific software hosted on a remote server to provide tailored educational content to individual users based on their respective personal user profiles.

System 10 includes a number of personal computing devices in the form of mobile devices 12 of the users. Mobile devices 12 are each associated with a different user or may be different devices of the same user. Mobile devices 12 include wearable devices, desktop computers, laptops, smartphones, tablets, biometric readers, optical implants, augmented reality devices such as headsets and virtual reality devices such as headsets.

System 10 includes a remote computer in the form of a central server or servers 20 accessible by devices 12 over a communications network 22. Server 20 is in communication with a database 24. Database 24 may be part of server 20.

System 10 includes an applications program, hereby termed the “App”, executed on devices 12.

Mobile devices 12 are preferably commercially available, conventional mobile devices. Some of the basic functions which mobile devices 12 preferably include are: a touch sensitive graphical screen interface; a cellular radio transceiver; a GPS chip or receiver and associated antenna; an internal clock; and the ability to run or execute an application, including the App. In the examples that follow, specific coding for the App has been omitted for simplicity as a person of ordinary skill in the art would be able to understand and reproduce the functionality of the described embodiments without the need for discussion on particular coding.

The location for download of the App may depend on the operating system of device 12. In one embodiment, mobile device 12 is an iPhone®, manufactured and sold by Apple, Inc. and runs the iOS operating system, and the app may be downloaded from the App Store. For phones running the Android operating system the App may be downloaded from the Google Play store and similarly for phones running the Windows operating system the App may be downloaded from the Windows store.

Communications network 22 includes a cellular or mobile broadband network and the internet to connect devices 12 to server 20. Devices 12 connect to communications network 22 via a cellular or mobile broadband connection or via a wireless access point such as Wi-Fi. It is further envisaged that the system can be configured to provide off-line content, caching and off-line access with periodic callbacks of queued data via the network to the server 20 when online access is available.

Server 20 is a computer that can be accessed over network 22. Server 20 would typically include one or more CPU's and one or more high-capacity storage devices such as hard drives, solid-state drives, flash disks and the like. The hardware of server 20 may be any of a number of off-the-shelf servers known to those skilled in the art of computing. Server 20 stores information in database 24 as discussed in more detail below.

Server 20 may be managed or administrated by an administrator of system 10. Server 20 has system management software executed thereon which administrates system 10. Server 20 may be a physical server or a cloud based server. Server 20 may thus be hosted by a third party in either a shared or dedicated hosting arrangement.

The App is typically used in combination with one or more processors of device 12, and where it is hosted, configures what might otherwise be a general purpose processor into a special purpose processor according to the functions and parameters of the App. Preferably, the App is downloaded to a computer readable medium such as a memory in mobile device 12.

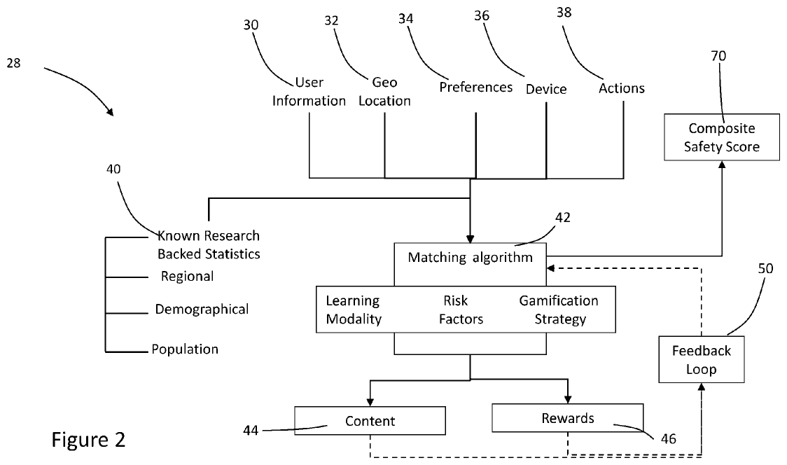

Referring to FIG. 2, a method 28 of tailoring educational content as part of an adaptive learning program is depicted diagrammatically. Method 28 is implemented by system 10 of FIG. 1.

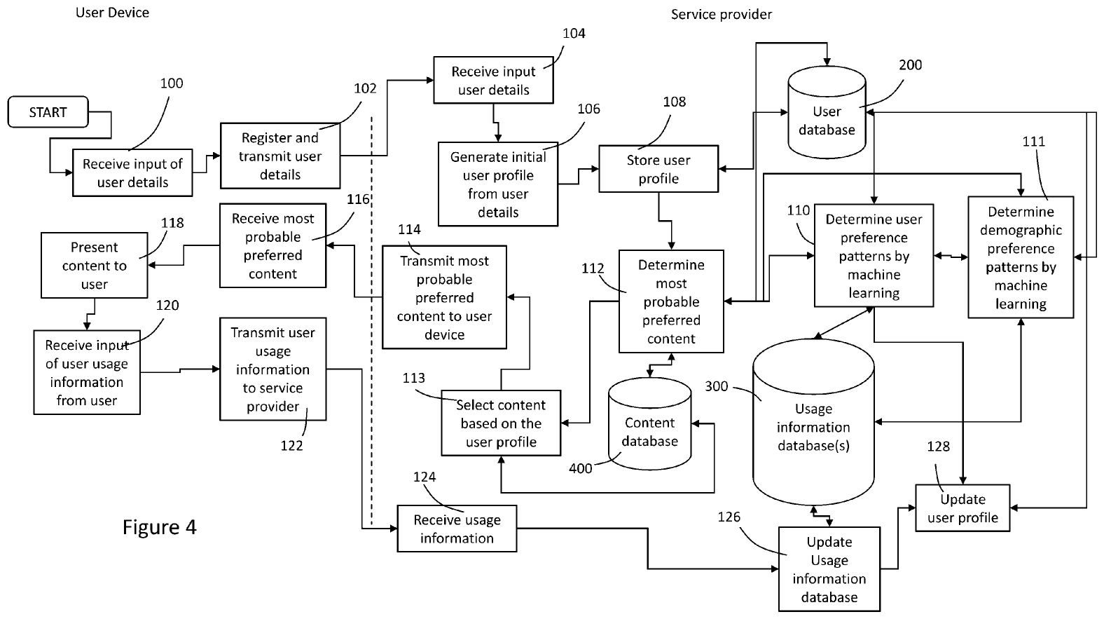

System 10 builds a comprehensive user profile of each user by datamining information from multiple sources. The user profile is built by system 10 using information gathered form the multiple sources via the App. The information sources include requested user information 30, geo-location data 32, user preferences 34, device information 36 and user actions 38. The methods of datamining the different sources of information 30-38 is discussed in more detail below, with reference to FIG. 4.

User information 30 is collected from a user when they engage with system 10 via the user device 12 during a user registration process. The user is requested to log into system 10 via the App using his/her login details or an otherwise distinct internet platform, such as Facebook, Twitter, LinkedIn or Gmail. The user is prompted to provide his/her login details via a graphical user interface (GUI) displayed by the App on mobile device 10. Once logged in, server 20 can retrieve the user's available biographical information from the other platform using an applications program interface (API). Alternately, the user device can receive 100 biographical information from the user via the app by direct input from the user. The biographical information is then transmitted 102 to and received 104 by the service provider system 20.

Server 20 will prompt the user to provide any outstanding user information 30 which could not by retrieved using the API. For example, the unassociated internet platform may not grant permission for the date of birth (DOB) of the user to be released to system 10. Server 20 will then prompt the user via the GUI to provide their DOB in order to collect the required user information.

User information is aggregated from the unassociated internet platform using the login details as discussed above and supplemented by selective prompting of the user in a post-login process. Examples of user information 30 that system 10 aggregates include raw metrics such as Gender, DOB, number of dependents, education level, income, etc.

The user's location and/or change of location is used as a source of information 32 that is transmitted to the service provider system 20. The user's location can be determined or estimated using a number of methods. The IP address for mobile device 12 can give a wide geo-location of the user. If the user allows the App access to the location services function of mobile device 12, the App can give a precise GPS location of the user at a specific instance in time, for example at registration.

Once the user's details have been received by the service provider system 20, the service provider system 20 will generate 106 an initial user profile from the user details. This initial user profile will be stored 108 on a user database 200.

The service provider system 20 preferably further includes a plurality of usage information database 300. Usage information databases 300 are databases of information that has been stored relating to usage that a user has made of content provided to them and the actions and interactions the user has made.

The service provider system 20 analyses information stored in the usage information databases to determine 110 patterns of usage by the user as user preference patterns. These user preference patterns are used to refine patterns relating to general demographic models as well as the individual user profile as neural matrices.

As user preference patterns are developed, these are overlaid to determine 111 demographic preference patterns. Such demographic preference patterns can be used as a “seed” pattern to provide content for a new user, for example before their individual user preference patterns are more fully developed.

The service provider system 20 is configured to determine 110 user preference patterns by using machine learning to analyse information contained in the user database 200 as well as the usage information databases 300.

The service provider system 20 further includes a content database 400 on which content items, such as media items in various formats (text, video, audio, virtual reality content, augmented reality content, or the like) are stored. It is envisaged that the content items can include, but are not limited to, items requiring the user to perform actions, view content, complete sub-goals, challenges and missions, and reach milestones. It is envisaged that many content databases 400 may be provided, and that the content databases 400 can be structured hierarchically or otherwise.

The service provider system 20 is configured to determine 112 the most probable preferred content that the user will most probably interact with from the determined user preference patterns. The most probable preferred content will be selected 113 from a content database 400, and transmit 114 the most probable preferred content to the user device 12.

Upon receiving 116 the most probable preferred content, the user device will present 118 these to the user. The user device 12 will then receive 120 input from the user indicative of the user's usage information, and will transmit 122 the usage information to the service provider system 20. Upon receiving 124 the usage information, the service provider system 20 will update 126 the usage information database 300. The updated usage information databases 300 is in turn analysed by machine learning to determine 110 updated user preference patterns, and update 128 the user profile on the user database 200. The updated usage information databases 300 are also analysed by machine learning to develop updated demographic preference patterns.

Information stored on the usage information databases 300 can include information about the discrete actions the user does or does not perform (for example viewing content, submitting a quiz, opening an app, video or picture, et cetera) in interacting with content provided to them, as well as meta data associated with those actions and/or content. Meta data can include, but is not limited to, for example, the number of times that specific content was interacted with, the size and font of headlines on an article, the colour palettes of a video or picture, the amount of time spent viewing particular content, and/or the general nature of content that is regularly viewed, and where, for example, that content fits in hierarchical content databases 400.

Updating 144 the usage information databases 300 will allow for increased accuracy in the determination of user preference patterns according to demographics, location, activities, et cetera. Updating the user's profile will allow for more accurate selection of content tailored to the user based on their determined user preference patterns preferences. The accumulated user preference patterns are used to build up a user profile that is a complex matrix of weightings, and that will dictate the selection 113 of content for presentation to the user

In this way, the user's response, or lack thereof, to particular content is fed back into the service provider system, allowing for the user's profile to be updated as a neural matrix. Feedback will strengthen and prioritise the pathways that achieve the optimum outcome (for example an educational outcome) in the quickest and most productive manner. When the user engages with the service provider system 20 at a later date, this updated neural matrix allows for content to be chosen for presentation to the user that has a higher probability of positive outcomes for the user, in preference to alternative content.

Each user's user profile or neural matrix is stored at an individual level and exists for each user in the system.

It is further envisaged that the neural matrices of user profiles of individual users can be overlaid onto the neural matrices of other demographically or statistically similar users, in order to highlight and promote recurring successful pathway patterns, or to demote content having a lower probability of success of producing a positive outcome to the user. The preference patterns highlighted by the overlay of such individual neural matrices of individual users with other demographically or statistically similar users can result in increasingly accurate “seed” user preference patterns that are used to determine the content to be presented to newly registered users. In this way, using seed user preference patterns that are statistically more likely to be preferred by a newly registered user, the user has a higher probability of achieving positive outcomes (e.g. achieving a goal, learning, etc).

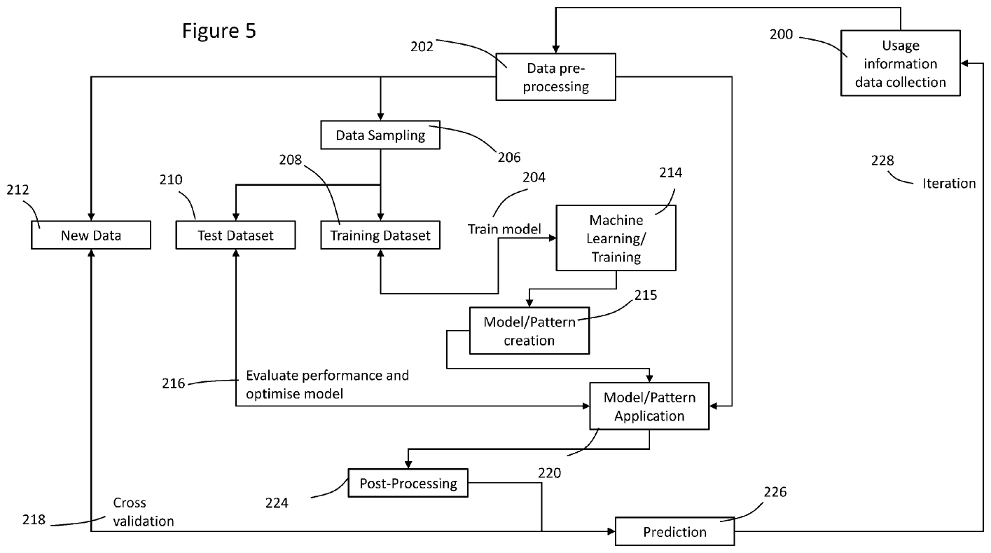

One example of machine learning that may take place with respect to the user profile information on the user database 200 and the usage information on the usage information database 300 is described with reference to FIG. 5.

Initially the process of collecting 200 usage information and/or user profile information is carried out as described above. Once the information has been collected, the data goes through a step of pre-processing 202. The data is then sampled 206, and from this, a Test Dataset 210 and a Training Dataset 208 is established.

The Training Dataset 208 is used to train the machine learning algorithms in a machine learning/training process 214. From this training the user preference patterns and/or demographic preference patterns are created 215.

The Test Dataset 210 is used to evaluate and optimise 216 the performance of the model or patterns that were created by applying 220 the created pattern to the Test Dataset 210. After this, post processing 224 occurs. After post processing, the model is used to generate predictions as to the content that the user will prefer. The provision of content will in turn generate the collection of more usage information, causing an iteration 228 of the process.

As new data 212 becomes available, the predictions are validated 218 against the users reactions to the content based on the success of the outcome.

The App is configured with a background location awareness feature which gives periodic updates to server 20 of user's broad location when a user moves from place to place, for example when a user leaves a city during weekdays and heads to the beach at the weekend. Each new location is added as a further source of information that may be fed back into the user's personal profile. The locations unlock location specific content for the user via a feedback loop as will be described below. The location awareness feature may be configured for use with a GPS-enabled mobile device, or other methods or hardware for location awareness as would be appreciated by those of ordinary skill in the art, for example only, triangulation methods and Bluetooth beacons.

The App may monitor user activity such as gyroscopic data feed from device 12 to provide movement data to server 20. The movement data gives system 10 an insight into the activity the user is preforming at any given time. For example, switching from a sedentary desk position to a running/walking motion. Server 20 is configured to learn user traits and user activity to update the user's personal profile, thereby to better tailor or dynamically customize the learning program and content to the user. For example, a user who runs frequently may be incentivised by other users who follow a similar activity pattern in other regions or their local area.

The App prompts the user to set or choose a number of preferences 34. As mentioned previously, the inputs received from the user as preferences 34 extend or enhances the user's personal profile to make the profile more comprehensive.

Preferences 34 may be gathered using a two choice selection interface presented to the user via the App. The selection interface may be picture based, such as showing a user a photo of an iPhone and an Android. The user selects their preferred option and the preferred option is highlighted with a bright outline the non-preferred option is greyed out. The preferred option is then centred on the screen and the non-preferred option reduces in size and falls away. Other examples of two choice selection interfaces include:

Male/Female depicted by a blue stick man and pink stick woman.

Marital status depicted by Single stick figure or Man and Woman figures.

Holiday mode: Photo of a beach vs photo of the snow.

Food preference: photo of healthy meal vs photo of fast food.

An additional or alternative method for preference selection uses swiping direction of left or right depending on the preference to a picture (left being negative, right being positive). The user would be displayed a series of photos within a similar category to gain insight into their preferences. Examples of photos that may be shown include different holiday locations, photos of beach, snow, water, city, green hills, etc.

The swiping direction method can be time based to answer as many preferences as possible within a time period of, for example 60 seconds. This will force users to answer on impulse. Points or scores can be awarded for consistency and other patterns can be identified to form part of the user's profile. The points or scores can then be compared to statistics of the user's peers, thus allowing gamification of the preference selection steps.

Device information 36 includes information on the device type and operating system type of mobile device 12. Device information is part of the input data to the user's personal profile.

The App is installed via market place that corresponds with the operating system of the user's device (i.e. Apple AppStore, Google Play, Microsoft Store). Given that the App is compiled against specific codebase and deployed to a specific store, system 10 is able to retrieve exact device type, model, operation system, version and other device capabilities. This information is passed to server 20 during the app start-up sequence. It is possible for the server 20 to detect a single user using multiple difference devices across different platforms. Additionally, the mobile device's browser sends a user-agent string to the server. This string indicates which browser mobile device 12 is using, its version number, and details about the operating system of mobile device 12 system.

The screen sizes of mobile device 12 and other device form factors can also be determined from the start-up sequence.

In the embodiment where the App is web-based, a user-agent string is used to identify information, which specifies the device type. Additional device metrics and compatibilities are determined from javascript functions that run within the web based app.

The App monitors the user's actions 38, for example the order of actions of the user while in interfacing with the App. The order of actions are registered as an input to the user's profile. For example, the App records each user's navigational journey or path during a user's active session using the App. The App can be configured so users follow a self on-boarding process.

The user's path is broken into a number of discrete steps. For example: App Opened, Device Handshake, User Authenticated (at this point system 10 knows who the logged in user is), User taps on Content A, then taps on Content B, fills in quiz C, submits quiz C, watches video D, uploads photo, check-in to a location, plays a game. This is then summarised into actions such as Open (App), Open (content A), Open (content B), Submit (form C), View (video D), Submit (photo), Visit (location) etc.

The actions a user takes as captured by the path are used as an input to adapting the learning modes and content delivered to the user. That is to say the profile of the user is updated based on the monitored user behaviour during a path of engaging with different content items. For example, depending on the options of various content items selected by the user in a path during a login, the system changes the learning mode, the content and/or the content delivery channel (e.g., the forum through which the content is delivered).

Data of the user's profile built using the inputs described above is processed by a matching algorithm of system 10. The matching algorithm matches the gathered data of the users profile data to predetermined statistical sets 40 or by using a dynamic lookup table. By matching the profile data to predetermined or known statistics 40, system 10 can categorize the user into different groups and/or assign specific content to the user.

For example, a matching algorithm 42 executed on server 20 will cross-correlate the user's profile of preferences 34 and user information 30 with statistics on health determination to categorise and/or group a user into a specific category or group. This allows server 20 to adapt to a user based on similar previous user's metrics and apply known learning programs to a user based on the outcomes of other matching users.

As an example, the statistics could indicate that men over forty-five in Texas, USA have a higher than likely chance of risk a specific disease. A user's personal profile as built up by server 20 determines that the user is highly correlated with this group as defined by the health determinants. Based on the group, the user is assigned a specific learning program with specific content. The user is assigned or categorized in a group which receives a learning program with tailored educational content based around reducing their risk for the specific disease. System 10 thus customises or adapts a learning program based on group pattern recognition. Attributes defining a group may include gender, age, economic experience, nationality, regional habitation, etc.

The user's personal profile, including preferences, are analysed by server 20 to determine the best learning modality for the user. The learning modalities may include video mode campaign, text campaign, score/leaderboard gaming, and length of delivery. The learning modality for the user is dynamically updated using a feedback loop 50 as discussed in more detail below.

Additional analysis by matching algorithm 42 generates risk factor indicators for the user, or measurements for comparison tests, based on the matching the user's profile to the predetermined statistics 40. Further testing and matching could include biometric indicators. The risk factor indicators are presented to the user as a Composite Safety Score 70. The Composite Safety Score is a weighted score of the risk factor indicators. Data collected at inputs 30 to 38 (FIG. 2) including, but not limited to, known information, have a weight/score applied to them. For example, if gender=female, the score is 1; if gender=male score is 2. If smoker=yes, the score is 1; if a non-smoker, the score is 5. These scores are predetermined and set at the point known information is fed into the system. A user's points will accumulate across all known information and information collected at inputs 30 to 38. This total number of points will be referred to as a composite score.

The composite score may be displayed to a user as part of their user profile information or as an incentive that is part of a gamification strategy. For example, a user will be shown their score and then may get a message to say that “you are only 10 points from achieving in the 1% most active and healthy non-smokers in your area.” They may then receive a notification alerting them to an activity or challenge that upon completion would lower their score a further 10 points. This is an example of a nonmonetary reward for incentivising a user to complete an action.

The score will change based on changes detected by matching algorithm 42 in combination with one or more of inputs 30 to 38. For example, if a user records that they have stopped smoking, their score will go from a “1” to a “5”, therefore changing the overall composite score 70.

Server 20 assigns a specific gamification strategy for content to be delivered to the user based on the group into which matching algorithm 42 categorizes the user. Server delivers the most likely relevant content 44 for the user based on the group match. Content 44 is then displayed to the user via the App and the user begins to interact and absorb the content. The content format for the user is dynamically updated using a feedback loop 50 as discussed in more detail below. The user is rewarded with the rewards 46 most likely to motivate the user to consume content based on the assigned group for the user. The gamification reward strategy for the user is dynamically updated using a feedback loop 50 as discussed in more detail below.

Gamification reward strategies can be applied to individual users, or to selected groups of users. In addition, gamification reward strategies can include the provision of content in augmented reality or virtual reality spaces, allowing a user or selected groups of users to interact in such spaces.

System 10 continuously monitors the sources of information 30 to 38 for changes that may influence the user's personal profile, and thus change the learning program or how content is delivered. This continual feedback provides targeted updates to the user experience. For example, if the location 32 of mobile device changes then content or a learning program specific to that location may be delivered.

System 10 continuously monitors and tests the user's interactions via the App to match the content format, learning mode and gamification reward strategy which best suits the user. Matching of the content format, learning mode and gamification reward strategy is discussed in the paragraphs below.

### Content Format

Different users have different preferred formats for consuming and creating content. Three common formats of content available via server 20 are:
Video—Uploading/downloading and Watching Video
Photo—Uploading and Viewing photos
Text—Sharing, reading or creating text based content
Augmented reality content—uploading/downloading the dimensional and overlay content
Virtual reality content—uploading/downloading three-dimensional content

Server 20 is configured to test the applicability of these formats in the way of creating and presenting content for a user to consume. Feedback algorithm 42 as described in the diagram above monitors in real-time via feedback loop 50 which of the three formats described above is preferred by the user. Algorithm 42 will adapt by way of feeding this information back into the algorithm and/or profile of the user, which leads to more content in the format that the user prefers being offered to the user, or to selected groups of users.

### Learning Mode

Different users have different learning modes. Three common learning modes offered by server 20 are:

Visual

Auditory

Kinaesthetic

In one embodiment, each of the content items are stored on the content database in association with an indication of the learning mode, or modes, that they apply to.

Server 20 is configured to test variations of all of these modes in the way of creating and presenting content for a user to consume. Feedback algorithm 42 monitors in real-time which of three modes described above is preferred by the user. System 10 adapts by way of feeding this information back into the algorithm using feedback loop 50 and/or profile of the user. System 10 is thus able to adapt to offer the user more of the content in the learning mode that the user prefers.

### Gamification Reward Strategy

Different users respond differently to different gamification reward strategies. Three common gamification reward strategies are:

Products—Real Life/Tangible rewards

Moments—moments that money cannot buy

Virtual—perceived achievements leader boards, points, stamps

In one embodiment, each of the gamification reward strategies are stored on the content database in association with an indication that they are a gamification reward strategy and the type, or types, of gamification reward strategy that they apply to.

Server 20 is configured to test variations of these gamification reward strategies in the way of incentivizing the user to consume and create content. System 10 monitors in real-time which strategy best engages the user. System 10 adapts in response to the observations by way of rewarding the user in accordance with gamification reward strategy shown to be most effective for the particular user.

Users are automatically placed into groups upon logging into the platform. The group the user is placed in is based on the user's personal profile. Users will be placed into groups based on the best match between know statistics and the profile data of the user. A user can be a member of many groups and will see the relevant content only to those groups. Matching procedures provide for optimal grouping.

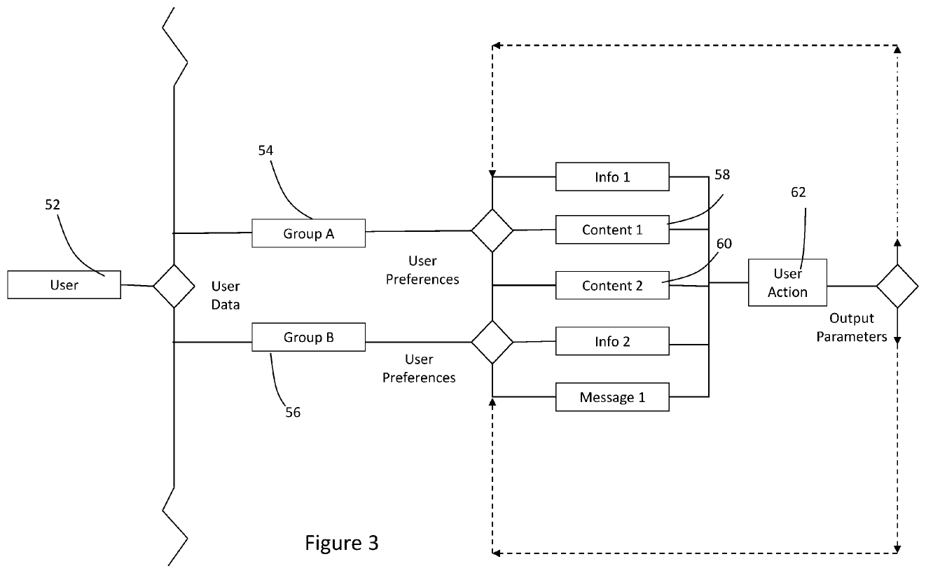

Referring to FIG. 3, a user 52 is shown as being able to belong to two groups 54 and 56. Different content 58, 60 is delivered to user 52 depending on the group 54, 56 in which he/she is categorized. User 52's actions 62 are monitored to update the user's preferences in the user's profile. The content 58, 60 is delivered to user 52 in the learning mode, content format, and gamification reward strategy as per the user's preferences detailed in his/her profile.

The system and platform of the present application applies personalized gamification strategies and incentives to how educational content is delivered to a user. By delivering the educational content as part of a gamification strategy with incentives, the behavioral intent of the user can be positively affected to deliver desired results.

For example, algorithm 42 may be configured to test different incentives for each user as a person of ordinary skill in the art would appreciate that each person is motivated by different rewards or incentives. For example, a user may be asked what motivates them via a series of images on the screen. One image may be monetary, another of a family holiday, and one or more further images presented that relate to prior experiences. When a user chooses an image, they will be then presented with several more options. The user will continue this process until they find the exact topic, image or incentive that motivates them.

The system will then present content by way of photos, videos or text, and prompt a user that they can have the reward, or begin to move towards receiving that reward, by engaging in and completing content.

An exemplary gamification strategy used throughout the system is to reward users with real life rewards for completing different actions. A gamification strategy does not need to create a game per se, but may offer a gameful experience to all users. Such an experience could also be provided in an augmented reality or virtual reality space over, for example, a mobile device or an augmented reality or virtual reality headset.

Another example would be the user creating a composite score leaderboard to see where they compare against their friends and family.

The features described with respect to one embodiment may be applied to other embodiments, or combined with, or interchanged with, the features of other embodiments without departing from the scope of the present invention.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1-16. (canceled)

17. A method of establishing user preference patterns through machine learning, including:
transmitting content to a personal computing device of the user for presentation to the user;
receiving usage information indicative of the user's interaction with the content;
analyzing the usage information using machine learning to determine user preference patterns, the analysis including:
sampling usage information;
generating a training dataset;
training the machine learning model;
generating user preference patterns;
applying the user preference patterns to test dataset; and
generating a prediction of content to be transmitted to the user;
updating a personal profile of the user to reflect the determined user preference patterns, the user profile being configured as a neural matrix; and
transmitting content to the user in accordance with the user's personal profile.

18. The method of claim 17, wherein the user preference patterns of a plurality of users are used to determine a demographic preference pattern.

19-20. (canceled)

21. The method of claim 17, wherein the analysis of the usage information includes the analysis of usage information relating to the discrete actions performed or not performed by the user, as well as meta data associated with the user's actions and/or content that the user has interacted with.

22-25. (canceled)

26. The method of claim 17, wherein the method includes the storing of content in association with a mode selected from visual mode, audio mode and kinaesthetic mode.

27. The method of claim 26, wherein the selection of content associated with one of the visual, audio and/or kinaesthetic modes for presentation to the user is determined in accordance with the user profile.

28. The method of claim 17, wherein the determination of user preference patterns does not require the receipt of a selection of alternative content by the user.

29. The method of claim 17, wherein the content formats include one or more selected from video, photo, virtual reality content, augmented reality content and text.

30. The method of claim 17, wherein a method includes determining demographic preference patterns from plurality of user preference patterns and user profiles.

31. The method of claim 30, wherein the determination of demographic preference patterns is by machine learning.

32. The method of claim 30, including categorizing the user into one or more demographic groups based on the matching of the user's personal profile to a demographic preference pattern, and tailoring content transmitted to the user's personal computing device is based on the demographic group into which the user is categorised, and in accordance with demographic preference patterns.

33. The method of claim 18, including applying a selection of two or more different gamification strategies to how content is presented to best engage the user with the content in accordance with the user profile:
generating a user preference pattern that reflects the gamification strategy that results in the best engagement by the user in the achievement of predetermined goals;
updating the user's personal profile in accordance with the generated user preference pattern; and
disseminating content to a user's computing device in accordance with the updated user's personal profile.

34. The method of claim 18, including datamining biographical information from multiple sources to build a comprehensive personal profile of the user.

35. The method of claim 18, wherein the user's personal profile is created from:
use information received from the user;
geolocation data received from the user's personal computing device; and
user preference patterns determined from usage information.

36. A dynamic system for analyzing and disseminating educational content to a personal computing device based on detected user preference patterns, comprising:
a central server including, or connected to, a content database with educational content in different formats;
wherein said central server is configured to disseminate educational content to a personal computing device associated with a user, for presentation to a user;
said central server being configured to receive usage information from the personal computing device, the usage information being indicative of the interaction by the user with content presented to the user;
said central server being configured to determine user preference patterns from the usage information, and to update a personal profile of the user in accordance with the detected user preference patterns;
said central server being configured to select content for transmission to a user's personal computing device based on the user's personal profile.

37. The dynamic system of claim 36, wherein said educational content is disseminated to the user in a format corresponding with a preferred learning mode as determined from the user preference patterns.

38. (canceled)

39. The dynamic system of claim 36, wherein said received usage information includes information relating to the discrete actions performed or not performed by the user, as well as metadata associated with the user's actions and/or content that the user has interacted with.

40. (canceled)

41. The dynamic system of claim 36, wherein the content database includes educational content associated with at least one or more different gamification strategies, and the server is configured to transmit content to a user's personal computing device associated with at least one of the gamification strategies in accordance with the user's user profile.

42. The dynamic system of claim 36, wherein said server is configured to determine demographic preference patterns from a plurality of user preference patterns and a plurality of user profiles.

43. The dynamic system as claimed in claim 42, wherein the demographic preference patterns are used to categorise a user into a demographic group.

44. The dynamic system as claimed in claim 43, wherein server is configured to tailor the content selected for transmission to said user's personal computing device based on the demographic group into which the user is categorised.
